(19) United States
(12) Patent Application Publication
(10) Pub. No.: US 2026/0030783 A1
(43) Pub. Date: Jan. 29, 2026

(54) METHOD AND SYSTEM FOR CALIBRATING THREE-DIMENSIONAL MEASUREMENT SYSTEM BASED ON RAY MODEL

(71) Applicant: SHENZHEN TECHNOLOGY UNIVERSITY, Shenzhen City (CN)

(72) Inventors: Xiaoshuo ZHANG, Shenzhen City (CN); Hailong CHEN, Shenzhen City (CN); Shuyi XU, Shenzhen City (CN); Weikun LIN, Shenzhen City (CN); Haotian TANG, Shenzhen City (CN); Jiemei WANG, Shenzhen City (CN); Huazhi ZHANG, Shenzhen City (CN); Jinhao CHEN, Shenzhen City (CN)

(73) Assignee: SHENZHEN TECHNOLOGY UNIVERSITY, Shenzhen City (CN)

(21) Appl. No.: 19/266,076

(22) Filed: Jul. 10, 2025

(30) Foreign Application Priority Data
Jul. 23, 2024 (CN) 202410985369.6

(51) Int. Cl. G06T 7/80; G06T 5/80

(52) U.S. Cl. CPC G06T 7/80; G06T 5/80; G06T 2207/30204; G06T 2207/30244

(57) ABSTRACT

Provided is a method and system for calibrating a three-dimensional (3D) measurement system based on a ray model. The method includes: acquiring corresponding target images at multiple poses, as well as corresponding phase-shifted fringe images and Gray code images; performing center correction on each of the target images to acquire center coordinates of marker points in each of the target images; triangulating the center coordinates of the target images at each target pose to acquire triangular mesh data; calculating object points corresponding to each target pose in a camera coordinate system from each pixel of the target images based on the triangular mesh data, thereby acquiring an object point set corresponding to each pixel, and determining a ray parameter corresponding to the object point set; performing phase extraction on the phase-shifted fringe images and the Gray code images to acquire absolute phase data corresponding to each pixel; and determining a 3D mapping coefficient by coefficient fitting based on the object point set and the absolute phase data corresponding to each pixel, and constructing a lookup table based on the 3D mapping coefficient and the ray parameter to achieve camera calibration.

### CROSS REFERENCE TO RELATED APPLICATION

This patent application claims the benefit and priority of Chinese Patent Application No. 202410985369.6, filed with the China National Intellectual Property Administration on Jul. 23, 2024, the disclosure of which is incorporated by reference herein in its entirety as part of the present application.

### TECHNICAL FIELD

The present disclosure relates to the technical field of image detection, and in particular to a method and system for calibrating a three-dimensional (3D) measurement system based on a ray model, an electronic device, a storage medium, and a computer program product.

### BACKGROUND

Imaging system calibration is one of the crucial tasks in the field of machine vision (MV). In related art, cameras and projectors are calibrated through a ray model that imposes demanding requirements on the calibration target. For example, to solve spatial points, the target plane needs to be fitted as an ideal plane. Consequently, if the three-dimensional (3D) sensor has a large field of view (FOV), fabricating targets with high flatness will be difficult and expensive. If the flatness of a large-sized planar target is insufficient, the calibration accuracy of ray calibration will be compromised.

### SUMMARY

To address the above technical issues, the present disclosure provides a method and system for calibrating a three-dimensional (3D) measurement system based on a ray model, an electronic device, a storage medium, and a computer program product. The present disclosure can reduce requirements for target flatness and simplify the calibration process.

A first aspect of the present disclosure provides a method for calibrating a 3D measurement system based on a ray model, where the method includes:
acquiring corresponding target images at multiple target poses, as well as corresponding phase-shifted fringe images and Gray code images;
performing center correction on each of the target images to acquire center coordinates of marker points in each of the target images;
triangulating the center coordinates of the target images at each target pose to acquire triangular mesh data;
calculating object points corresponding to each target pose in a camera coordinate system from each pixel of the target images based on the triangular mesh data, thereby acquiring an object point set corresponding to each pixel, and determining a ray parameter corresponding to the object point set;
performing phase extraction on the phase-shifted fringe images and the Gray code images to acquire absolute phase data corresponding to each pixel; and
determining a 3D mapping coefficient by coefficient fitting based on the object point set and the absolute phase data corresponding to each pixel, and constructing a phase-to-3D mapping coefficient lookup table based on the 3D mapping coefficient and the ray parameter to achieve camera calibration.

In an embodiment, the performing center correction on each of the target images to acquire center coordinates of marker points in each of the target images includes:
constructing a center arrangement network for the target images;
defining an image plane corresponding to a parallel-view camera coordinate system of the target images;
determining a geometric transformation matrix based on the center arrangement network, where the geometric transformation matrix is configured to transform the center arrangement network to a target position on the image plane corresponding to the parallel-view camera coordinate system;
determining a homography matrix based on the geometric transformation matrix and intrinsic and extrinsic parameters of the target images, where the homography matrix is configured to perform coordinate system transformation for the target images between the camera coordinate system and the parallel-view camera coordinate system; and
acquiring corresponding corrected center coordinates of the marker points in the target images at each target pose based on the homography matrix.

In an embodiment, the triangulating the center coordinates of the target images at each target pose to acquire triangular mesh data includes:
triangulating the center coordinates of the marker points in the target images corresponding to each target pose through a triangulation method, and dividing the target image into multiple planes to acquire the triangular mesh data.

In an embodiment, the calculating object points corresponding to each target pose in a camera coordinate system from each pixel of the target images based on the triangular mesh data, thereby acquiring an object point set corresponding to each pixel includes:
traversing, for pixels in the target image, barycentric coordinates of each triangle in the triangular mesh data to determine a target triangle corresponding to the pixels;
constructing a barycentric coordinate coefficient based on geometric relationships between the pixels and vertices of the target triangle; and
determining target points in the target images at each target pose corresponding to the pixels according to an imaging assumption of the ray model, thereby acquiring an object point set corresponding to each pixel.

In an embodiment, the method further includes: sorting all center coordinates on the image plane through a four-circle ordering algorithm, and constructing a lookup table between center points on the image plane and corresponding center points of a target plane in the camera coordinate system.

In an embodiment, the method further includes:
performing 3D reconstruction based on the phase-to-3D mapping coefficient lookup table.

In an embodiment,

The performing 3D reconstruction based on the phase-to-3D mapping coefficient lookup table includes:
projecting a unidirectional fringe image onto an object under measurement, and determining absolute phase data of a pixel of the object under measurement;
querying the phase-to-3D mapping coefficient lookup table based on the absolute phase data to determine a corresponding phase-to-3D mapping coefficient; and
determining 3D coordinates of the pixel of the object under measurement based on the phase-to-3D mapping coefficient.

A second aspect of the present disclosure provides a system for calibrating a 3D measurement system based on a ray model, where the system includes:
an image acquisition module, configured to acquire corresponding target images at multiple target poses, as well as corresponding phase-shifted fringe images and Gray code images;
a center correction module, configured to perform center correction on each of the target images to acquire center coordinates of marker points in each of the target images;
a triangulation module, configured to triangulate the center coordinates of the target images at each target pose to acquire triangular mesh data;
an object point calculation module, configured to calculate object points corresponding to each target pose in a camera coordinate system from each pixel of the target images based on the triangular mesh data, thereby acquiring an object point set corresponding to each pixel, and determine a ray parameter corresponding to the object point set;
a phase calculation module, configured to perform phase extraction on the phase-shifted fringe images and the Gray code images to acquire absolute phase data corresponding to each pixel; and
a lookup table construction module, configured to determine a 3D mapping coefficient by coefficient fitting based on the object point set and the absolute phase data corresponding to each pixel, and construct a phase-to-3D mapping coefficient lookup table based on the 3D mapping coefficients and the ray parameters to achieve camera calibration.

A third aspect of the present disclosure further provides an electronic device, including: a memory and a processor, where the memory is configured to store a computer program; and the computer program is executed by the processor to implement the steps of the method according to any one of the embodiments in the first aspect.

A fourth aspect of the present disclosure further provides a computer-readable storage medium, where the computer-readable storage medium is configured to store a computer program; and the computer program is executed by a processor to implement the steps of the method according to any one of the embodiments in the first aspect.

A fifth aspect of the present disclosure further provides a computer program product, including: a computer program, where the computer program is executed by a processor to implement the steps of the method according to any one of the embodiments in the first aspect.

In the method for calibrating a 3D measurement system based on a ray model, parallel projection correction of the target images is achieved by performing center correction on the target images at multiple target poses to obtain the corresponding corrected center coordinates of the marker points. The center coordinates at each target pose are triangulated to obtain triangular mesh data. Based on the triangular mesh data, the object point sets corresponding to each pixel and the fitted ray parameter are calculated, thereby solving the 3D coordinates of the pixels based on barycentric coordinate mapping. In this way, the present disclosure reduces requirements for target flatness and avoids errors from treating the target plane as an ideal plane. The entire calibration process requires only images of a single planar target captured at multiple poses, effectively simplifying the calibration procedure and enhancing data processing efficiency.

### BRIEF DESCRIPTION OF THE DRAWINGS

FIG. 1 is a schematic diagram of a method for calibrating a 3D measurement system based on a ray model in an embodiment;

FIG. 2 is a schematic diagram of a camera coordinate system and a parallel-view camera coordinate system in an embodiment;

FIG. 3 is a schematic diagram of coordinate components corresponding to a triangle in an embodiment;

FIG. 4 is a schematic diagram of transformations among a marker point in a target image, a marker point in the parallel-view camera coordinate system, and a marker point after center correction in an embodiment;

FIG. 5 is a schematic diagram of coordinate point projection in an embodiment;

FIG. 6 is a schematic diagram of ray rendering in an embodiment;

FIG. 7 is a schematic diagram of two spatial lines intersecting in the camera coordinate system and a projector coordinate system in an embodiment;

FIG. 8 is a flowchart of the method for calibrating a 3D measurement system based on a ray model in an embodiment;

FIG. 9 is a schematic diagram of a system for calibrating a 3D measurement system based on a ray model in an embodiment; and

FIG. 10 is a structural diagram of an electronic device in an embodiment.

### DETAILED DESCRIPTION OF THE EMBODIMENTS

To make the objectives, technical solutions, and advantages of the present disclosure clearer, the present disclosure is further described in detail below with reference to the drawings and embodiments. It should be understood that the specific embodiments described herein are merely used to explain the present disclosure, rather than to limit the present disclosure.

During camera calibration in related art, when solving for spatial points, the target plane is fitted as an ideal plane. If the 3D sensor has a large field of view (FOV), fabricating targets with high flatness is difficult and expensive. If the flatness of a large-sized planar target is insufficient, it will compromise the calibration accuracy in ray calibration. Additionally, in camera ray calibration, a liquid crystal display (LCD) target must be used first before switching to a planar target for solving 3D points, which complicates the process.

To overcome the technical deficiencies in the prior art, an embodiment of the present disclosure provides a method for calibrating a 3D measurement system based on a ray model.

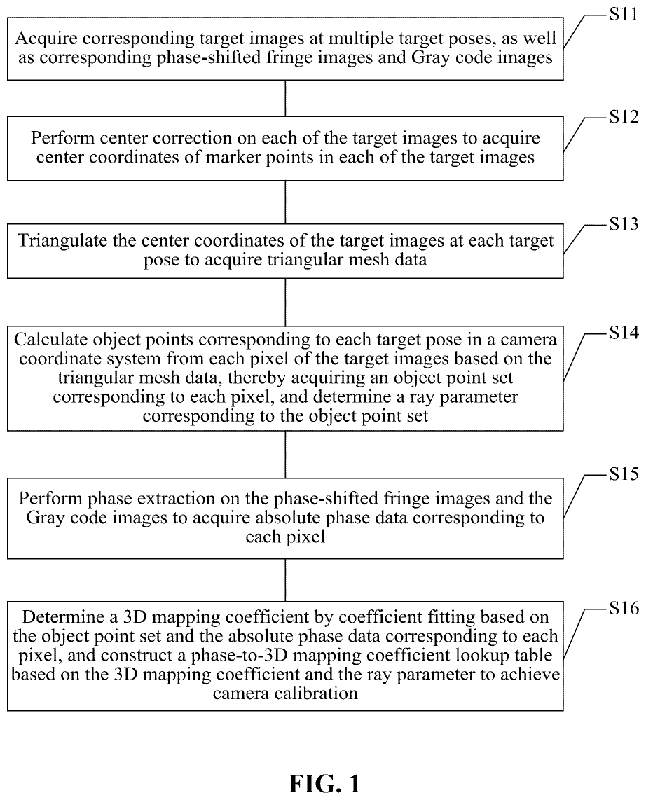

As shown in FIG. 1, an exemplary embodiment provides a method for calibrating a 3D measurement system based on a ray model. The method is applicable to smart electronic devices equipped with imaging capabilities such as digital cameras and camera modules assembled in smart terminal devices. Exemplarily, the method for calibrating a 3D measurement system based on a ray model may include steps S11 to S16. Specifically:

S11. Corresponding target images at multiple target poses are acquired, as well as corresponding phase-shifted fringe images and Gray code images.

In an exemplary embodiment, a sensor system is formed using one industrial camera and one digital projector. During calibration, a target is placed within a measurement space of the sensor system, and target poses of the target are preconfigured. For example, K poses of the target within the measurement space are preconfigured, where K≥10. At each target pose, the angle and distance between the target and a camera plane differ. At each pose, the industrial camera acquires one grayscale image of the target. The projector and the camera project and capture one set of phase-shifted fringe images and Gray code images in a single direction, with n>4 phase-shifting steps controlled for acquiring the phase-shifted fringe images.

S12. Center correction is performed on each of the target images to acquire center coordinates of marker points in each of the target images.

Exemplarily, due to perspective transformation in the camera imaging process, when a camera shooting direction is not parallel to a target plane, circular marker points of the target captured by the camera become ellipses. At this time, an ellipse center extracted by a center extraction algorithm in the image is not an image point corresponding to a center of the circular marker point, i.e., a perspective deviation exists. Center deviation reduces the accuracy of solving object points with the ray model, and therefore center correction is required.

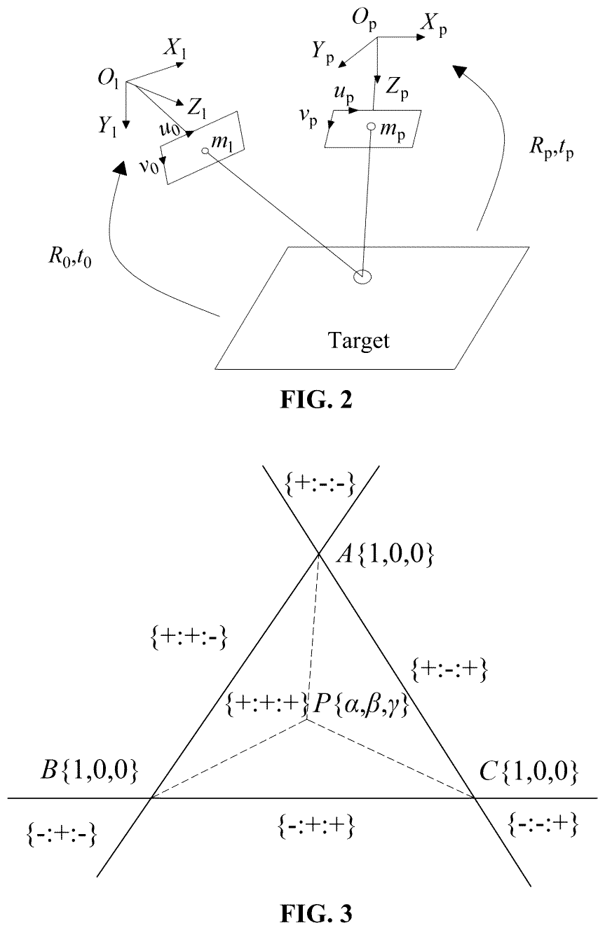

Referring to FIG. 2, O₁ denotes a camera coordinate system, and Oₚ denotes a parallel-view camera coordinate system. A transformation relationship between the target image in the camera coordinate system and the target image in the parallel-view camera coordinate system is expressed as:

$$( \begin{matrix}{u}_{p} \\ {v}_{p} \\ 1\end{matrix} ) = {H}_{p} * {( \begin{matrix}{R}_{0} & {t}_{0} \\ {0}^{T} & 1\end{matrix} )}^{- 1} * {K}_{0}^{- 1} * ( \begin{matrix}{u}_{0} \\ {v}_{0} \\ 1\end{matrix} ) \qquad ( 1 )$$

$${H}_{p} = {K}_{p} * ( \begin{matrix}{R}_{p} & {t}_{p} \\ {0}^{T} & 1\end{matrix} ) \qquad ( 2 )$$

where, K₀ and Kₚ are intrinsic parameters of the camera; R₀ and t₀ are extrinsic parameters of the camera in a world coordinate system; Rₚ and tₚ are extrinsic parameters of the corresponding target in the parallel-view coordinate system; u₀ and v₀ denote coordinates of a pixel, for example, point m₁, in an original target image in the camera coordinate system; and uₚ and vₚ denote coordinates of a pixel, for example, point mₚ, in the parallel-view camera coordinate system.

Considering that the world coordinate system where the target is located is fixed, regardless of the positional relationship of the coordinate system O₁ relative to the world coordinate system, the optimal parallel-view pose Oₚ and the relative position of the target in the world coordinate system are both determined. Therefore, the transformation relationship Hₚ can be characterized by calculating a homography matrix of these two planes. The parallel view requires the camera to be directly above the target, with a FOV covering the entire target and a moderately sized circle on the imaging plane.

In an exemplary embodiment, the step S12 that the center correction is performed on each of the target images to acquire the center coordinates of the marker points in each of the target images includes the following sub-steps.

S121. A center arrangement network is constructed for the target images.

S122. An image plane corresponding to the parallel-view camera coordinate system of the target images is defined.

S123. A geometric transformation matrix is determined based on the center arrangement network. The geometric transformation matrix is configured to transform the center arrangement network to a target position on the image plane corresponding to the parallel-view camera coordinate system.

S124. A homography matrix is determined based on the geometric transformation matrix and the intrinsic and extrinsic parameters of the target images. The homography matrix is configured to perform coordinate system transformation for the target images between the camera coordinate system and the parallel-view camera coordinate system.

S125. Corresponding corrected center coordinates of the marker points in the target images at each target pose are acquired based on the homography matrix.

Exemplarily, a standard center arrangement network is first generated according to center row and column numbers of the target and center distances in x and y directions. Image plane uₚ, vₚ, with a custom input resolution is then generated, for example, the image plane uₚ, vₚ corresponding to the parallel-view camera coordinate system shown in FIG. 2.

When the geometric transformation matrix is calculated, four corner points of the center arrangement network are determined. A midpoint is obtained by averaging, and then a midpoint of the image plane is calculated. Displacement offsets tₓ and t_{y} are determined by calculating a difference between the two midpoints. Scaling factor (scale) is then determined. Since the scaling is proportional, the scaling factor is a minimum value of a difference between image plane width/corner coordinates xₘₐₓ−xₘᵢₙ and a difference between image plane height/corner coordinates yₘₐₓ−yₘᵢₙ. To prevent the corner points from being at image edges, a certain width is retained, and 8/10 of image height and width are taken for calculation. The geometric transformation matrix is configured to position the standard center arrangement network at a centered and appropriately sized location on the image plane in the parallel-view camera coordinate system.

Then, the homography matrix Hₚ for transformation between the two planes is calculated based on the center point on the image plane and the center point of the target image in the camera coordinate system.

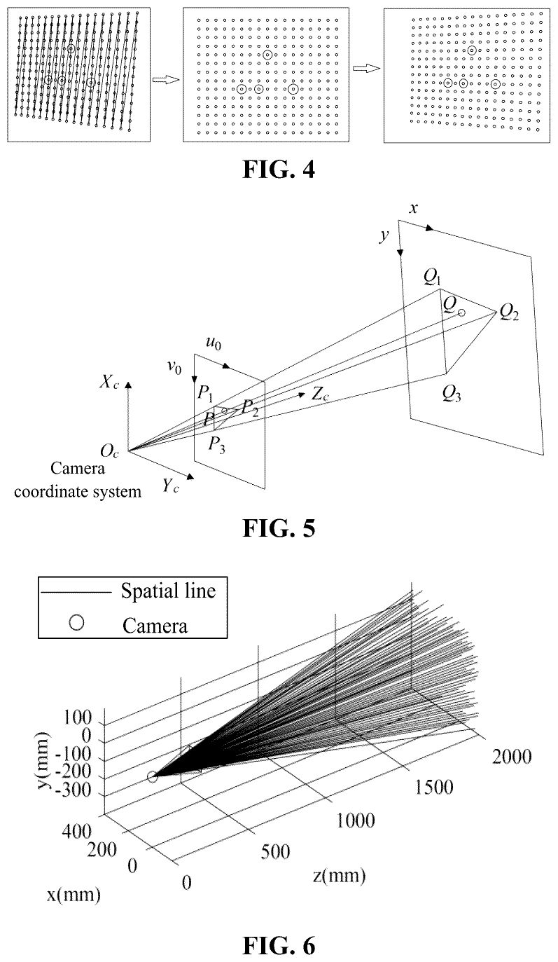

After the homography matrix Hₚ is obtained, for the image plane uₚ, vₚ, inverse mapping to the original image plane u₀, v₀, is performed according to the transformation relationship in Eq. (2). An image in the parallel view is then obtained through bilinear interpolation. At this time, a center point set in the parallel view is acquired using a center extraction algorithm, and the point set is inversely mapped from the parallel view back to the original image. Thus, the image plane is obtained. Corrected center coordinates of circular marker points for the target at each target pose on the image plane are thereby obtained, as shown in FIG. 4.

Additionally, extrinsic parameter matrices corresponding to the target at different target poses are determined using a Zhang Zhengyou calibration method.

S13. The center coordinates of the target images at each target pose are triangulated to acquire triangular mesh data.

In an exemplary embodiment, the step that the center coordinates of the target images at each target pose are triangulated to acquire triangular mesh data is as follows. The center coordinates of the marker points in the target images corresponding to each target pose are triangulated through a triangulation method, and the target image is divided into multiple planes to acquire the triangular mesh data.

Exemplarily, in a calibration scenario with a large FOV, the target often cannot be directly regarded as an ideal plane. In this case, a finite element method is adopted. The target is divided into multiple small planes through triangulation, and 3D coordinates of points on the plane are solved based on barycentric coordinates.

Specifically, all center coordinates obtained from the target image captured at each pose first undergo triangulation through the triangulation method to obtain triangular mesh {(Pᵢ, Pⱼ, Pₖ)}.

For any point P on plane ABC determined by any triangle ΔABC in space, triangle area ratio S_{ΔPBC}:S_{ΔAPC}:S_{ΔABP}=α:β:γ is defined as barycentric coordinates (or area coordinates) of point M relative to triangle ΔABC, denoted as: M=(α:β:γ)={α, β, γ} Areas ΔPBC, ΔAPC, and ΔABP are all directed areas. Conventionally, when vertices of a triangle are arranged counterclockwise, the triangle area is positive. When the vertices are arranged clockwise, the area is negative. Correspondingly, the area coordinate components α, β, and γ all are directed, as shown in FIG. 3.

S14. Object points corresponding to each target pose in the camera coordinate system are calculated for each pixel of the target images based on the triangular mesh data, thereby acquiring an object point set corresponding to each pixel, and a ray parameter corresponding to the object point set is determined.

In an exemplary embodiment, the step that the object points corresponding to each target pose in the camera coordinate system are calculated for each pixel of the target images based on triangular mesh data, thereby acquiring an object point set corresponding to each pixel includes the following sub-steps.

S141. For pixels in the target image, barycentric coordinates of each triangle in the triangular mesh data are traversed to determine a target triangle corresponding to the pixels.

S142. Barycentric coordinate coefficients are constructed based on geometric relationships between the pixel and vertices of the target triangle.

S143. Target points in the target images at each target pose corresponding to the pixels are determined according to an imaging assumption of the ray model, thereby acquiring an object point set corresponding to each pixel.

Exemplarily, for pixel m in the target image on the image plane in the camera coordinate system, barycentric coordinates of the pixel relative to all triangles {(Pᵢ, Pⱼ, P_{K})} are calculated by traversal. The three vertices of a certain triangle are denoted as P₁(x₁, y₁), P₂(x₂>y₂), P₃(x₃, y₃), and coordinates of point P(pₓ, p_{y}) on the triangular plane are then expressed as:

$$P = α {P}_{1} + β {P}_{2} + γ {P}_{3} \qquad ( 3 )$$

where, α, β, and γ are barycentric coordinate coefficients, satisfying α+β+γ=1.

Correspondingly:

$$α = \frac{( {p}_{y} - {y}_{3} ) ( {x}_{2} - {x}_{3} ) + ( {y}_{2} - {y}_{3} ) ( {x}_{3} - {p}_{x} )}{( {y}_{1} - {y}_{3} ) ( {x}_{2} - {x}_{3} ) + ( {y}_{2} - {y}_{3} ) ( {x}_{3} - {x}_{1} )} \\ β = \frac{( {p}_{y} - {y}_{1} ) ( {x}_{3} - {x}_{1} ) + ( {y}_{3} - {y}_{1} ) ( {x}_{1} - {p}_{x} )}{( {y}_{1} - {y}_{3} ) ( {x}_{2} - {x}_{3} ) + ( {y}_{2} - {y}_{3} ) ( {x}_{3} - {x}_{1} )} \\ γ = \frac{( {p}_{y} - {y}_{2} ) ( {x}_{1} - {x}_{2} ) + ( {y}_{1} - {y}_{2} ) ( {x}_{2} - {p}_{x} )}{( {y}_{1} - {y}_{3} ) ( {x}_{2} - {x}_{3} ) + ( {y}_{2} - {y}_{3} ) ( {x}_{3} - {x}_{1} )} \qquad ( 4 )$$

The barycentric coefficients express the geometric relationships between the point and vertex coordinates. The relationships between the point and the triangle are determined by signs of α, β, and γ. The point P lies inside the triangle only when α, β, and γ are all greater than 0. When the triangle including the point P is determined, the corresponding barycentric coordinate coefficients can be determined.

According to the imaging assumption of the ray model, the target points S₁, S₂, S₃ . . . , on the target image at each target pose are imaged onto the same pixel m. The point on the target image is transformed to the camera coordinate system through the following relationship:

$$( \begin{matrix}{R}_{1} & {t}_{1} \\ {0}^{T} & 1\end{matrix} ) {S}_{1} , ( \begin{matrix}{R}_{2} & {t}_{2} \\ {0}^{T} & 1\end{matrix} ) {S}_{2} , ( \begin{matrix}{R}_{3} & {t}_{3} \\ {0}^{T} & 1\end{matrix} ) {S}_{3} , … …$$

R₁, R₂, R₃ denote rotation matrices of the target corresponding to a first pose, a second pose, and a third pose relative to the camera, respectively. t₁, t₂, t₃ denote translation matrices of the target corresponding to the first pose, the second pose, and the third pose relative to the camera, respectively. Extrinsic parameters at different poses are obtained via center correction through the Zhang Zhengyou calibration method.

In an exemplary embodiment, the method further includes the following steps. All center coordinates are sorted on the image plane through a four-circle ordering algorithm, and a lookup table is constructed between center points on the image plane and corresponding center points of a target plane in the camera coordinate system.

Exemplarily, in the parallel-view camera coordinate system, all the center coordinates are sorted on the image plane through the four-circle ordering algorithm. The lookup table LUT{Pₙ|Qₙ} between center point Pₙ on the image plane and corresponding center point Qₙ of the target plane in the camera coordinate system is then constructed.

For any pixel m, after triangle vertices P₁, P₂, P₃ of the target at a k-th pose are obtained, 3D coordinates of corresponding spatial points Q₁, Q₂, Q₃ is retrieved from the target lookup table via the center point lookup table.

At this time, the geometric relationship determined by the barycentric coordinates can be transferred from the pixel plane to the camera coordinate system to solve for the 3D coordinates of point Q corresponding to any point P in the pixel plane, as shown in FIG. 5.

Due to nonlinear effects of perspective transformation, the barycentric coordinate coefficients of the point P obtained from the pixel plane are not equivalent to the barycentric coefficients of the corresponding point Q in the camera coordinate system. Therefore, perspective correction is first required. The space after projection transformation is regarded as a nonlinear space related to 1/z. Then, only one nonlinear transformation of the three vertex attributes is needed, and attributes in a 1/z-based space are linearly interpolated through the barycentric coordinate coefficients based on 1/z:

$${Q}_{1 / z} = α \frac{{Q}_{1}}{{z}_{1}} + β \frac{{Q}_{2}}{{z}_{2}} + γ \frac{{Q}_{3}}{{z}_{3}} \qquad ( 5 )$$

Subsequently, Q_{1/z} is multiplied by reciprocal r obtained after linear interpolation of a 1/z space-based unit vector to obtain the coordinates of the point Q:

$$Q = {Q}_{1 / z} r \qquad ( 6 )$$

$$r = \frac{1}{α \frac{1}{{z}_{1}} + β \frac{1}{{z}_{2}} + γ \frac{1}{{z}_{3}}} \qquad ( 7 )$$

Correspondingly, a true coordinate expression of the point Q based on the barycentric coordinates includes:

$$Q = {Q}_{1 / z} r = \frac{a \frac{{Q}_{1}}{{z}_{1}} + β \frac{{Q}_{2}}{{z}_{2}} + γ \frac{{Q}_{3}}{{z}_{3}}}{a \frac{1}{{z}_{1}} + β \frac{1}{{z}_{2}} + γ \frac{1}{{z}_{3}}} \qquad ( 8 )$$

Meanwhile, a spatial line equation is represented by a parametric equation:

$$\{ \begin{matrix}X = θ Z + a \\ Y = ηZ + b\end{matrix} \qquad ( 9 )$$

For the pixel m, true object point Q coordinates set in the camera coordinate system is solved using the above equations. A spatial line passing through these points is fitted via a least squares method to calculate a covariance matrix:

$${COV}_{ij} = \frac{1}{N - 1} {\sum }_{n = 1}^{N} ( {Q}_{ij}^{n} - {\overline{Q}}_{ij} ) {( {Q}_{ij}^{n} - {Q}_{ij} )}^{T} \qquad ( 10 )$$

$${\overline{Q}}_{ij} = \frac{1}{N} {\sum }_{n = 1}^{N} {Q}_{ij}^{n} \qquad ( 11 )$$

Based on the principal component analysis (PCA) theory, the eigenvector corresponding to the largest eigenvalue of the covariance matrix is a direction vector of the spatial line. The line must pass through a centroid. All spatial lines are thus characterized to obtain the ray parameters {θᵢⱼ, nᵢⱼ, aᵢⱼ, bᵢⱼ}. A rendering result of the ray parameters is shown in FIG. 6. In FIG. 6, multiple lines represent the spatial lines, and a circle where multiple lines converge denotes the camera.

For any pixel m corresponding to K object points, the covariance matrix of the object points is calculated, and the eigenvector corresponding to the largest eigenvalue of the covariance matrix is calculated and represented as a direction vector of a spatial line. The line must pass through a centroid. The ray parameters are thus determined based on the point and the direction.

S15. Phase extraction is performed on the phase-shifted fringe images and the Gray code images to acquire absolute phase data corresponding to each pixel.

In an exemplary embodiment, absolute phase ϕ_{c} of the image point on the image plane of the camera is extracted through an N-step phase-shifting method combined with Gray code phase unwrapping. Relative phases corresponding to all pixels are obtained by combining N phase-shifted fringe images at one pose. The absolute phase ϕ_{c} is then obtained by Gray code phase unwrapping.

S16. A 3D mapping coefficient is determined by coefficient fitting based on the object point set and the absolute phase data corresponding to each pixel. A phase-to-3D mapping coefficient lookup table is constructed based on the 3D mapping coefficients and the ray parameters to achieve camera calibration.

Exemplarily, after the coordinates of the object points in space are obtained, a mapping relationship between the phase of the image point and the 3D point is solved. Thus, the corresponding 3D spatial point is directly obtained from the phase of the image point.

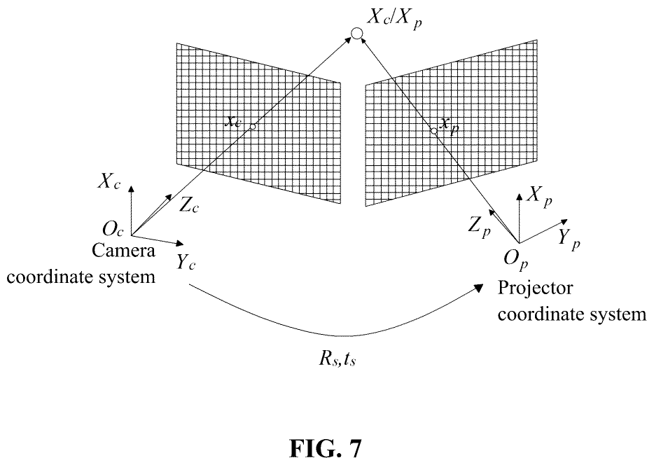

Specifically, referring to FIG. 7, two spatial lines passing through coordinate points x_{c} and xₚ in the two coordinate systems intersect at spatial point X_{c} and satisfy the following relationship:

$$\{ \begin{matrix}{X}_{P} = {R}_{s} {X}_{C} + {t}_{s} \\ λ {\tilde{x}}_{p}^{′} = [ I \vert 0 ] {\tilde{X}}_{p}\end{matrix} \qquad ( 12 )$$

where, \tilde{X}ₚ is a homogeneous coordinate; Rₛ is a rotation matrix from the camera coordinate system to the projector coordinate system; and tₛ is a translation matrix from the camera coordinate system to the projector coordinate system.

Based on Eq. (9) and Eq. (12), Xₚ is expressed as:

$$\{ \begin{matrix}λ {\tilde{x}}_{p}^{′} = {X}_{p} \\ {λ}_{f} {θ}_{p} + {a}_{p} = {X}_{p}\end{matrix} \qquad ( 13 )$$

where, θₚ=(θₚ, ηₚ, 1)^{T} and aᵢⱼ=(aₚ, bₚ, 0)^{T} denote ray parameters of camera rays in the projector coordinate system; and λ_{f} is a scaling constant.

Based on the above equations, line constraint

$${{\tilde{x}}_{p}^{T} [ {a}_{p} ]}_{\times } {θ}_{p} = 0$$

is obtained. [aₚ]ₓ denotes a skew-symmetric matrix of aₚ. The equation system then has only three degrees of freedom and is solvable. xₚ and ϕ_{c} satisfy a polynomial mapping relationship. A Z-coordinate of the object point X_{c} is obtained:

$${Z}_{p} = \frac{1}{{\sum }_{n = 0}^{N} {c}_{n} {ϕ}_{c}^{n}} \qquad ( 14 )$$

Therefore, the relationship between the 3D point on the camera ray and the phase is polynomial. cₙ is a 3D mapping coefficient obtained by coefficient fitting after coordinate transformation of the solved 3D point coordinates Q(X_{c}, Y_{c}, Z_{c}) and unwrapping of the phase ϕ_{c}.

After Zₚ is determined, coordinates Xₚ and Yₚ are calculated according to Eq. (9). The 3D coordinates of X_{C} are calculated by combining coordinate system transformation. Thus, the phase-to-3D mapping coefficient lookup table LUT{mᵢⱼ|θᵢⱼ, nᵢⱼ, aᵢⱼ, bᵢⱼ, cₙ} is constructed. Through the above derivation, the image points can be directly mapped to the corresponding 3D spatial point via the phase ϕ_{c} as long as the ray parameters {θᵢⱼ, nᵢⱼ, aᵢⱼ, bᵢⱼ} and the 3D mapping coefficient cₙ are determined.

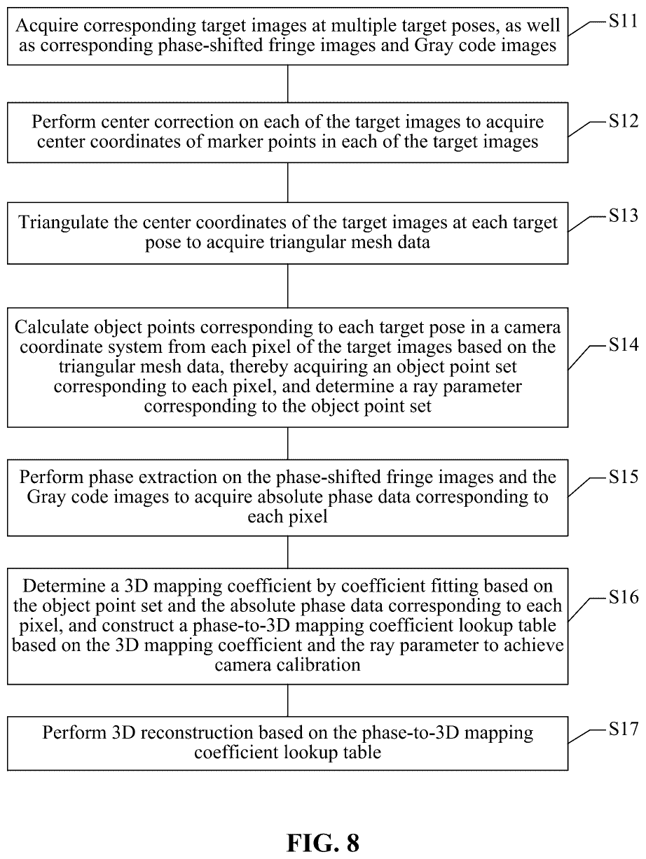

In an exemplary embodiment, referring to FIG. 8, the method further includes the following step. S17. 3D reconstruction is performed based on the phase-to-3D mapping coefficient lookup table.

In an exemplary embodiment, the step that the 3D reconstruction is performed based on the phase-to-3D mapping coefficient lookup table includes the following sub-steps.

S171. A unidirectional fringe image is projected onto an object under measurement, and absolute phase data of a pixel of the object under measurement is determined.

S172. The phase-to-3D mapping coefficient lookup table is queried based on the absolute phase data to determine a corresponding phase-to-3D mapping coefficient.

S173. 3D coordinates of the pixel of the object under measurement are determined based on the phase-to-3D mapping coefficient.

Specifically, the absolute phase ϕ_{c} is calculated by projecting a unidirectional fringe image onto a surface of the object under measurement. The phase-to-3D mapping coefficient corresponding to the image point mᵢⱼ is retrieved from the lookup table LUT. The phase and the 3D mapping coefficient are substituted into Eq. (13) to calculate corresponding X, Y, and Z coordinates.

In the method for calibrating a 3D measurement system based on a ray model provided by the embodiment of the present disclosure, the target is placed at multiple different poses. Corresponding target images are captured at different poses, and fringe and Gray code images are projected and captured. Center coordinates of the target at each pose are calculated via parallel projection correction. Extrinsic parameter matrices at each pose are calculated via the Zhang Zhengyou calibration method to achieve parallel projection correction of the target images. The center coordinates are triangulated to obtain triangular mesh data. K object points corresponding to each pixel are calculated via the triangular mesh based on the barycentric coordinates. The ray parameters are fitted to solve the 3D coordinates of each pixel based on the barycentric coordinates. The absolute phase is calculated by projecting and capturing the fringe images. Mapping coefficients are fitted through the object points and the phase. The phase-to-3D mapping coefficient lookup table is constructed, and 3D reconstruction is performed based on the phase-to-3D mapping coefficient lookup table. In this solution, the triangular mesh data is constructed by triangulating the center coordinates. The spatial coordinates of the 3D points are solved through barycentric coordinate mapping. This is equivalent to dividing the target plane into multiple small planes through a finite element method, reducing requirements for target flatness and avoiding errors from treating the target plane as an ideal plane. The entire calibration process requires only one planar target, simplifying the calibration procedure.

It should be understood that although the steps in the flowcharts in the above embodiments are shown in sequence as indicated by the arrows, these steps are not necessarily performed in sequence as indicated by the arrows. The execution order of these steps is not strictly limited, and these steps may be executed in other orders, unless clearly described otherwise. Moreover, at least some of the steps in the flowcharts in the above embodiments may include a plurality of steps or stages. The steps or stages are unnecessarily executed at the same time, but may be executed at different times. The execution order of the steps or stages is unnecessarily carried out sequentially, but may be executed alternately with other steps or at least some of the steps or stages of other steps.

Based on the same inventive concept, an embodiment of the present disclosure further provides a system configured to implement the method for calibrating a 3D measurement system based on a ray model. A problem-solving implementation solution provided by the system is similar to the implementation solution of the above method. Specific limitations in one or more embodiments of the system for calibrating a 3D measurement system based on a ray model provided below may refer to above limitations for the method for calibrating a 3D measurement system based on a ray model. Details are not repeated herein.

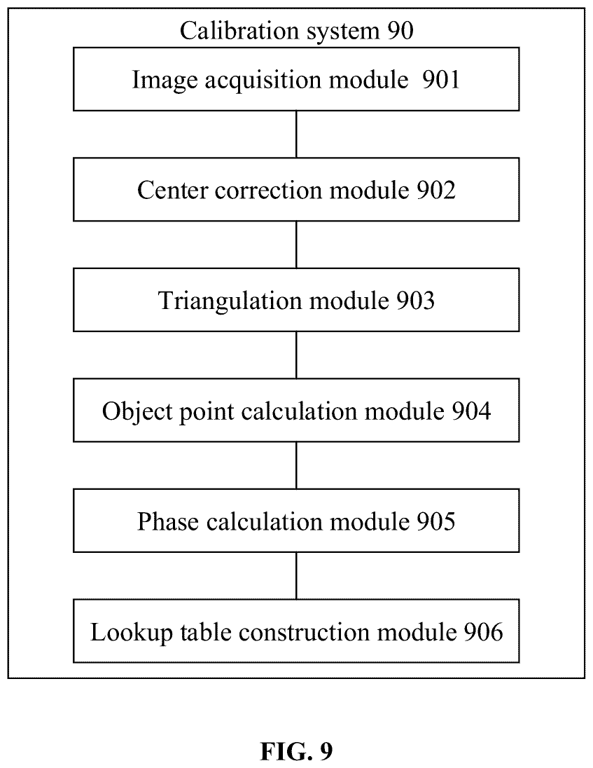

As shown in FIG. 9, an embodiment provides a system for calibrating a 3D measurement system based on a ray model. The calibration system 90 includes: an image acquisition module 901, a center correction module 902, a triangulation module 903, an object point calculation module 904, a phase calculation module 905, and a lookup table construction module 906.

The image acquisition module 901 is configured to acquire corresponding target images at multiple target poses, as well as corresponding phase-shifted fringe images and Gray code images.

The center correction module 902 is configured to perform center correction on each of the target images to acquire center coordinates of marker points in each of the target images.

The triangulation module 903 is configured to triangulate the center coordinates of the target images at each target pose to acquire triangular mesh data.

The object point calculation module 904 is configured to calculate object points corresponding to each target pose in a camera coordinate system from each pixel of the target images based on the triangular mesh data, thereby acquiring an object point set corresponding to each pixel, and determine a ray parameter corresponding to the object point set.

The phase calculation module 905 is configured to perform phase extraction on the phase-shifted fringe images and the Gray code images to acquire absolute phase data corresponding to each pixel.

The lookup table construction module 906 is configured to determine a 3D mapping coefficient by coefficient fitting based on the object point set and the absolute phase data corresponding to each pixel, and construct a phase-to-3D mapping coefficient lookup table based on the 3D mapping coefficients and the ray parameters to achieve camera calibration.

In an embodiment, the system further includes a reconstruction module, configured to perform 3D reconstruction based on the phase-to-3D mapping coefficient lookup table.

Various modules in the above system for calibrating a 3D measurement system based on a ray model may be implemented fully or partially through software, hardware, and a combination thereof. The modules may be embedded in or independent of a processor of a computer device in a form of hardware, or stored in a memory of the computer device in a form of software, such that the processor can easily invoke and execute corresponding operations of the modules.

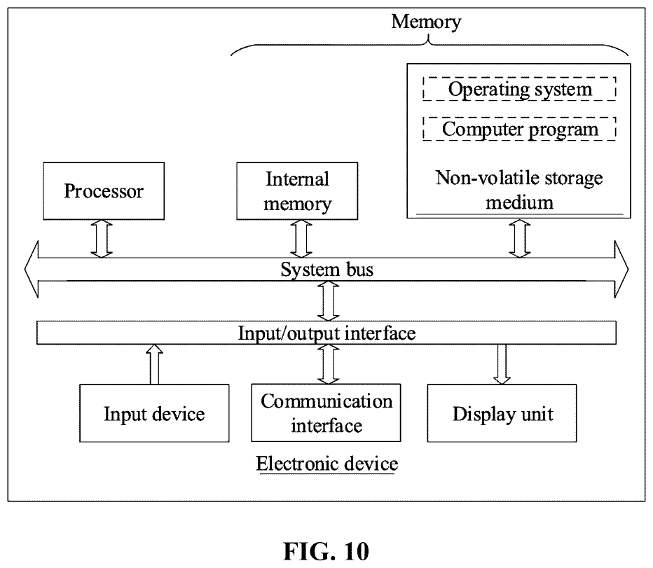

An embodiment provides an electronic device, and its structural diagram is shown in FIG. 10. The electronic device includes a processor, a memory, an input/output interface, a communication interface, a display unit, and an input device. The processor, the memory, and the input/output interface are connected through a system bus. The communication interface, the display unit, and the input device are connected to the system bus through the input/output interface. The processor of the computer device is configured to provide computing and control capabilities. The memory of the computer device includes a nonvolatile storage medium and an internal memory. The nonvolatile storage medium stores an operating system and a computer program. The internal memory provides an environment for execution of the operating system and computer programs in the nonvolatile storage medium. The input/output interface of the computer device is configured to exchange information between the processor and an external device. The communication interface of the computer device is configured for wired or wireless communication with an external terminal. Wireless communication can be achieved through wireless fidelity (WiFi), cellular mobile networks, near-field communication (NFC) or other means. The computer program is executed by the processor to implement the method for calibrating a 3D measurement system based on a ray model. The display unit of the computer device is configured to render visually perceptible images, and it may include a display screen, a projection apparatus, or a virtual reality (VR) imaging apparatus. The display screen may be an LCD or an e-ink display; the input device of the computer device may be a touch layer covering the display screen, or a key, a trackball or a touchpad set on a housing of the computer device, an external keyboard, touchpad or mouse, or the like.

Those skilled in the art may understand that the structure shown in FIG. 8 is only a block diagram of a part of the structure related to the solutions of the present disclosure and does not constitute a limitation on a computer device to which the solutions of the present disclosure are applied. Specifically, the computer device may include more or less components than those shown in the figure, or combine some components, or have different component arrangements.

An embodiment further provides an electronic device, including a memory and a processor, where the memory is configured to store a computer program; and the computer program is executed by the processor to implement the steps of the above method embodiments.

An embodiment provides a computer-readable storage medium. The computer-readable storage medium is configured to store a computer program, and the computer program is executed by a processor to implement the steps of the above method embodiments.

An embodiment provides a computer program product. The computer program product includes a computer program, and the computer program is executed by a processor to implement the steps of the above method embodiments. The computer program can be loaded onto a computer or other programmable data processing devices, such that a series of operating steps are performed on the computer or other programmable devices to generate computer-implemented processing, and instructions executed on the computer or other programmable devices provide steps for implementing the functions specified in the above method embodiments.

It should be noted that the user information (including but not limited to user device information and personal information) and data (including but not limited to data for analysis, stored data, and displayed data) covered by the present disclosure are all authorized by users or explicitly permitted by relevant parties. The acquisition, use, and processing of relevant data comply with applicable laws, regulations, and standards in relevant regions and countries.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present disclosure may include at least one of a nonvolatile and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magneto resistive random access memory (MRAM), a ferroelectric random access memory (FRAM), a phase change memory (PCM), a graphene memory, etc. The volatile memory may include a random access memory (RAM) or an external cache memory, etc. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include, but is not limited to, a distributed database based on a blockchain. The processor in the embodiments of the present disclosure may be, but is not limited to, a general processor, a central processor, a graphics processor, a digital signal processor (DSP), a programmable logic device, and a data processing logic device based on quantum computing.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on at least one computer-usable storage medium (including but not limited to a magnetic disk memory, a CD-ROM, an optical memory, and the like) that include computer-usable program code.

The above embodiments are merely illustrative of several implementations of the present disclosure, and the description thereof is more specific and detailed, but is not to be construed as a limitation to the patentable scope of the present disclosure. It should be noted that, for a person of ordinary skill in the art, several variations and improvements can be made without departing from the concept of the present disclosure, all of which fall within the protection scope of the present disclosure. Therefore, the protection scope of the present disclosure should be subject to the protection scope defined by the appended claims.

1. A method for calibrating a three-dimensional (3D) measurement system based on a ray model, wherein the method comprises:
acquiring corresponding target images at multiple target poses, as well as corresponding phase-shifted fringe images and Gray code images;
performing center correction on each of the target images to acquire center coordinates of marker points in each of the target images;
triangulating the center coordinates of the target images at each target pose to acquire triangular mesh data;
calculating object points corresponding to each target pose in a camera coordinate system from each pixel of the target images based on the triangular mesh data, thereby acquiring an object point set corresponding to each pixel, and determining a ray parameter corresponding to the object point set;
performing phase extraction on the phase-shifted fringe images and the Gray code images to acquire absolute phase data corresponding to each pixel; and
determining a 3D mapping coefficient by coefficient fitting based on the object point set and the absolute phase data corresponding to each pixel, and constructing a phase-to-3D mapping coefficient lookup table based on the 3D mapping coefficient and the ray parameter to achieve camera calibration.

2. The method according to claim 1, wherein the performing center correction on each of the target images to acquire center coordinates of marker points in each of the target images comprises:
constructing a center arrangement network for the target images;
defining an image plane corresponding to a parallel-view camera coordinate system of the target images;
determining a geometric transformation matrix based on the center arrangement network, wherein the geometric transformation matrix is configured to transform the center arrangement network to a target position on the image plane corresponding to the parallel-view camera coordinate system;
determining a homography matrix based on the geometric transformation matrix and intrinsic and extrinsic parameters of the target images, wherein the homography matrix is configured to perform coordinate system transformation for the target images between the camera coordinate system and the parallel-view camera coordinate system; and
acquiring corresponding corrected center coordinates of the marker points in the target images at each target pose based on the homography matrix.

3. The method according to claim 1, wherein the triangulating the center coordinates of the target images at each target pose to acquire triangular mesh data comprises:
triangulating the center coordinates of the marker points in the target images corresponding to each target pose through a triangulation method, and dividing the target image into multiple planes to acquire the triangular mesh data.

4. The method according to claim 1, wherein the calculating object points corresponding to each target pose in a camera coordinate system from each pixel of the target images based on the triangular mesh data, thereby acquiring an object point set corresponding to each pixel comprises:
traversing, for pixels in the target image, barycentric coordinates of each triangle in the triangular mesh data to determine a target triangle corresponding to the pixels;
constructing a barycentric coordinate coefficient based on geometric relationships between the pixels and vertices of the target triangle; and
determining target points in the target images at each target pose corresponding to the pixels according to an imaging assumption of the ray model, thereby acquiring an object point set corresponding to each pixel.

5. The method according to claim 4, wherein the method further comprises:
sorting all center coordinates on the image plane through a four-circle ordering algorithm, and constructing a lookup table between center points on the image plane and corresponding center points of a target plane in the camera coordinate system.

6. The method according to claim 1, wherein the method further comprises:
performing 3D reconstruction based on the phase-to-3D mapping coefficient lookup table.

7. The method according to claim 6, wherein the performing 3D reconstruction based on the phase-to-3D mapping coefficient lookup table comprises:
projecting a unidirectional fringe image onto an object under measurement, and determining absolute phase data of a pixel of the object under measurement;
querying the phase-to-3D mapping coefficient lookup table based on the absolute phase data to determine a corresponding phase-to-3D mapping coefficient; and
determining 3D coordinates of the pixel of the object under measurement based on the phase-to-3D mapping coefficient.

8. A system for calibrating a 3D measurement system based on a ray model, wherein the system comprises:
an image acquisition module, configured to acquire corresponding target images at multiple target poses, as well as corresponding phase-shifted fringe images and Gray code images;
a center correction module, configured to perform center correction on each of the target images to acquire center coordinates of marker points in each of the target images;
a triangulation module, configured to triangulate the center coordinates of the target images at each target pose to acquire triangular mesh data;
an object point calculation module, configured to calculate object points corresponding to each target pose in a camera coordinate system from each pixel of the target images based on the triangular mesh data, thereby acquiring an object point set corresponding to each pixel, and determine a ray parameter corresponding to the object point set;
a phase calculation module, configured to perform phase extraction on the phase-shifted fringe images and the Gray code images to acquire absolute phase data corresponding to each pixel; and
a lookup table construction module, configured to determine a 3D mapping coefficient by coefficient fitting based on the object point set and the absolute phase data corresponding to each pixel, and construct a phase-to-3D mapping coefficient lookup table based on the 3D mapping coefficient and the ray parameter to achieve camera calibration.

9. An electronic device, comprising a memory and a processor, wherein the memory is configured to store a computer program; and the computer program is executed by the processor to implement steps of the method according to claim 1.

10. (canceled)

11. The electronic device according to claim 9, wherein the performing center correction on each of the target images to acquire center coordinates of marker points in each of the target images comprises:
constructing a center arrangement network for the target images;
defining an image plane corresponding to a parallel-view camera coordinate system of the target images;
determining a geometric transformation matrix based on the center arrangement network, wherein the geometric transformation matrix is configured to transform the center arrangement network to a target position on the image plane corresponding to the parallel-view camera coordinate system;
determining a homography matrix based on the geometric transformation matrix and intrinsic and extrinsic parameters of the target images, wherein the homography matrix is configured to perform coordinate system transformation for the target images between the camera coordinate system and the parallel-view camera coordinate system; and
acquiring corresponding corrected center coordinates of the marker points in the target images at each target pose based on the homography matrix.

12. The electronic device according to claim 9, wherein the triangulating the center coordinates of the target images at each target pose to acquire triangular mesh data comprises:
triangulating the center coordinates of the marker points in the target images corresponding to each target pose through a triangulation method, and dividing the target image into multiple planes to acquire the triangular mesh data.

13. The electronic device according to claim 9, wherein the calculating object points corresponding to each target pose in a camera coordinate system from each pixel of the target images based on the triangular mesh data, thereby acquiring an object point set corresponding to each pixel comprises:
traversing, for pixels in the target image, barycentric coordinates of each triangle in the triangular mesh data to determine a target triangle corresponding to the pixels;
constructing a barycentric coordinate coefficient based on geometric relationships between the pixels and vertices of the target triangle; and
determining target points in the target images at each target pose corresponding to the pixels according to an imaging assumption of the ray model, thereby acquiring an object point set corresponding to each pixel.

14. The electronic device according to claim 12, wherein the method further comprises:
sorting all center coordinates on the image plane through a four-circle ordering algorithm, and constructing a lookup table between center points on the image plane and corresponding center points of a target plane in the camera coordinate system.

15. The electronic device according to claim 9, wherein the method further comprises:
performing 3D reconstruction based on the phase-to-3D mapping coefficient lookup table.

16. The electronic device according to claim 14, wherein the performing 3D reconstruction based on the phase-to-3D mapping coefficient lookup table comprises:
projecting a unidirectional fringe image onto an object under measurement, and determining absolute phase data of a pixel of the object under measurement;
querying the phase-to-3D mapping coefficient lookup table based on the absolute phase data to determine a corresponding phase-to-3D mapping coefficient; and
determining 3D coordinates of the pixel of the object under measurement based on the phase-to-3D mapping coefficient.
